(19) United States
(12) Patent Application Publication
(10) Pub. No.: US 2023/0023875 A1
(43) Pub. Date: Jan. 26, 2023

(54) INK SUPPLY TUBE

(71) Applicant: NITTA CORPORATION, Osaka-shi, Osaka (JP)

(72) Inventor: Tomoya HIOKI, Nabari-shi, Mie (JP)

(21) Appl. No.: 17/786,203

(22) PCT Filed: Dec. 16, 2020
(86) PCT No.: PCT/JP2020/047005

§ 371 Date: Jun. 16, 2022

(30) Foreign Application Priority Data
Dec. 17, 2019 (JP) 2019-227286
Dec. 16, 2020 (JP) 2020-208205

(51) Int. Cl. B32B 1/08; F16L 11/04; B32B 27/08; B32B 27/32; B32B 27/34; B41J 2/175

(52) U.S. Cl. CPC B32B 1/08; F16L 11/04; B32B 27/08; B32B 27/32; B32B 27/34; B41J 2/175; F16L 2011/047; B32B 2250/24; B32B 2307/7246; B32B 2307/412; B32B 2307/714; B32B 2307/546; B32B 2307/54; B32B 2597/00

(57) ABSTRACT

An ink supply tube includes: a first layer that is made of an unmodified ethylene-tetrafluoroethylene copolymer resin and is in contact with ink; a second layer that is made of a modified ethylene-tetrafluoroethylene copolymer resin and is formed on an outer periphery of the first layer; a third layer that is made of a polyamide resin or a basic functional group-modified polypropylene resin and is formed on an outer periphery of the second layer; a fourth layer that is made of an ethylene-vinyl alcohol copolymer resin having a gas barrier property and is formed on an outer periphery of the third layer; and a fifth layer that is made of an acid functional group-modified polypropylene resin and is formed on an outer periphery of the fourth layer.

### TECHNICAL FIELD

The present invention relates to an ink supply tube.

### BACKGROUND ART

As an ink supply tube having a multilayer structure, a tube has been disclosed that includes an inner layer in contact with ink, an intermediate layer consisting of at least one layer, and an outer layer, in which the inner layer is made of an ethylene-tetrafluoroethylene copolymer resin.

### CITATION LIST

### Patent Literature

PTL 1: JP 2011-062881 A

### SUMMARY OF THE INVENTION

### Technical Problem

In the case of PTL 1 described above, the ethylene-tetrafluoroethylene copolymer resin forming the inner layer is considered to be modified in order to obtain an adhesiveness with the intermediate layer. Since the inner layer made of the modified ethylene-tetrafluoroethylene copolymer resin has a modified group, when the inner layer comes into contact with the ink, the ink sticks to a surface of the inner layer, and a color residue occurs. In this case, when another kind of ink is flowed through the tube, a concern arises that the ink sticks to the surface of the inner layer when cleaning the inside so as not to be mixed with the new ink, leading to an extra time taken for the cleaning.

An object of the present invention is to provide an ink supply tube capable of suppressing the color residue of the ink.

### Solution to Problem

The ink supply tube according to the present invention includes: a first layer that is made of an unmodified ethylene-tetrafluoroethylene copolymer resin and is in contact with the ink; a second layer that is made of a modified ethylene-tetrafluoroethylene copolymer resin and is formed on an outer periphery of the first layer; a third layer that is made of a polyamide resin or a basic functional group-modified polypropylene resin and is formed on an outer periphery of the second layer; a fourth layer that is made of an ethylene-vinyl alcohol copolymer resin having a gas barrier property and is formed on an outer periphery of the third layer; and a fifth layer that is made of an acid functional group-modified polypropylene resin and is formed on an outer periphery of the fourth layer.

### Advantageous Effects of the Invention

According to the present invention, since the first layer is made of the unmodified ethylene-tetrafluoroethylene copolymer resin, the color residue of the ink can be suppressed.

### BRIEF DESCRIPTION OF DRAWING

FIG. 1 A perspective view of an ink supply tube according to the present embodiment with a part omitted.

### DESCRIPTION OF EMBODIMENTS

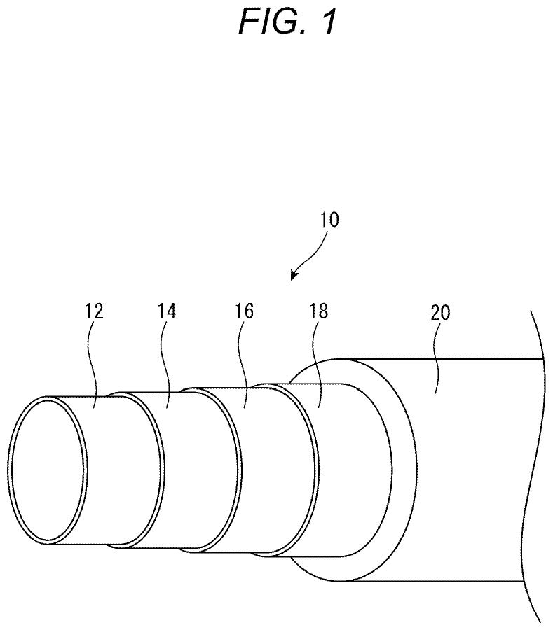

Hereinafter, embodiments of the present invention will be described in detail with reference to the drawing. FIG. 1 illustrates an ink supply tube 10 having a five-layer structure according to the present embodiment. The ink supply tube 10 is molded into a cylindrical shape having the five-layer structure by a co-extrusion molding. In other words, the ink supply tube 10 is formed through a method in which five types of resins are simultaneously extruded, laminated into the cylindrical shape, and molded in one step. The ink supply tube 10 includes a first layer 12, a second layer 14, a third layer 16, a fourth layer 18, and a fifth layer 20 in order from the inside. The first layer 12 is disposed on the innermost side, the second layer 14 is formed on an outer periphery of the first layer 12, the third layer 16 is formed on an outer periphery of the second layer 14, the fourth layer 18 is formed on an outer periphery of the third layer 16, and the fifth layer 20 is formed on an outer periphery of the fourth layer 18.

The first layer 12 is made of the ethylene-tetrafluoroethylene copolymer resin (hereinafter referred to as the “ETFE resin”). The ETFE resin of the first layer 12 is unmodified. The first layer 12 is made of the unmodified ETFE resin, and thereby has a chemical resistance and a low moisture permeability and can further suppress the color residue of the ink.

The second layer 14 is made of the modified ETFE resin (hereinafter referred to as the “modified ETFE resin”). The modified ETFE resin is obtained by introducing one or more functional groups consisting of a carboxyl group, a carboxylic acid anhydride residue, an epoxy group, a hydroxyl group, an isocyanate group, an ester group, an amide group, an aldehyde group, an amino group, a hydrolyzable silyl group, a cyano group, a carbon-carbon double bond, a sulfonic acid group, and an ether group. The second layer 14 is made of the modified ETFE resin, and thus has the chemical resistance and the low moisture permeability and is compatible with the unmodified ETFE resin.

The third layer 16 is made of the polyamide resin or the modified polypropylene resin (hereinafter referred to as the “modified polypropylene resin”). The third layer 16 is made of the polyamide resin, and thereby firmly adheres to the modified ETFE resin and the ethylene-vinyl alcohol copolymer resin (hereinafter referred to as the “EVOH resin”). The polyamide resin is preferably PA6-based, and may be any one or more of PA6, PA66, PA610, PA612, and PA614. The polyamide resin may be modified to improve an adhesive layer with the second layer 14 or the fourth layer 18. The modified polypropylene resin forming the third layer 16 is modified with the basic functional group. The third layer 16 is made of the modified polypropylene resin, and thereby has a transparency and the low moisture permeability, and firmly adheres to the modified ETFE resin and the EVOH resin since the modified polypropylene resin is modified with the basic functional group. The modified polypropylene resin of the third layer 16 is obtained by introducing a carbodiimide group.

The fourth layer 18 is made of the EVOH resin. The fourth layer 18 is made of the EVOH resin and thus has the gas barrier property. As an ethylene composition ratio becomes higher, the EVOH resin has a higher flexibility and a lower gas barrier property. As the ethylene composition ratio becomes lower, the EVOH resin has a lower flexibility and a higher gas barrier property. In consideration of a balance between the flexibility and the gas barrier property, the ethylene composition ratio is preferably 27 to 44 mol %. Furthermore, from the viewpoint of the flexibility and the gas barrier property, the ethylene composition ratio in the present embodiment is preferably 27 mol % or more and 32 mol % or less.

The fifth layer 20 is made of the modified polypropylene resin. The modified polypropylene resin forming the fifth layer 20 is modified with the acid functional group. The fifth layer 20 has the low moisture permeability and the transparency, and firmly adheres to the EVOH resin due to the modification with the acid functional group. The modified polypropylene resin of the fifth layer 20 is obtained by introducing an acrylic acid, a methacrylic acid, a maleic acid, a fumaric acid, an itaconic acid, anhydrides of these acids, or esters of these acids.

Thicknesses of all the layers of the ink supply tube 10 can be selected to be different according to uses. The gas barrier property can be further improved by disposing the fourth layer 18 made of the EVOH resin more inwardly in a radial direction of the tube. A ratio of a total thickness of the first layer 12, the second layer 14, the third layer 16, and the fourth layer 18 to a total thickness of the first layer 12, the second layer 14, the third layer 16, the fourth layer 18, and the fifth layer 20 is preferably 4/10 or less. For example, the thicknesses of the first layer 12 and the second layer 14 can be respectively 100 μm, the thicknesses of the third layer 16 and the fourth layer 18 can be respectively 50 μm, and the thickness of the fifth layer 20 can be 700 μm.

Further, in the ink supply tube 10, a ratio of a total thickness of the first layer 12, the second layer 14, and the third layer 16 to the total thickness of the first layer 12, the second layer 14, the third layer 16, the fourth layer 18, and the fifth layer 20 is preferably 4/10 or less. In such a case, for example, the thicknesses of the first layer 12 to the fourth layer 18 can be all 100 μm, and the thickness of the fifth layer 20 can be 600 μm. Accordingly, in the present embodiment, the thickness of the fourth layer 18 in the entire thickness of the ink supply tube 10 can be increased, and the gas barrier property can be further enhanced. In addition, by setting the ratio of the total thickness of the first layer 12 to the third layer 16 to the total thickness of the first layer 12 to the fifth layer 20 to 4/10 or less, the fourth layer 18 can be disposed more inwardly (on a side of the first layer 12) than the center of the entire thickness of the first layer 12 to the fifth layer 20. Moreover, as described above, when the ratio of the total thickness of the first layer 12 to the fourth layer 18 to the entire thickness of the first layer 12 to the fifth layer 20 is set to 4/10 or less, the fourth layer 18 can be disposed further inwardly. In the present embodiment, the gas barrier property of the ink supply tube 10 can be adjusted as described above.

Since the first layer 12 is made of the unmodified ETFE resin, the ink supply tube 10 has the chemical resistance and the low moisture permeability, and can additionally suppress the color residue of the ink. Since the first layer 12 and the second layer 14 are made of the same kind of resin, they are compatible with each other and can have a sufficient adhesiveness.

The third layer 16 is made of the polyamide resin having the amino group, and thereby can more firmly adhere to the modified ETFE resin forming the second layer 14 and the EVOH resin forming the fourth layer 18. The third layer 16 is made of the modified polypropylene resin into which the basic functional group has been introduced, and thereby can more firmly adhere to the modified ETFE resin forming the second layer 14 and the EVOH resin forming the fourth layer 18. Since the ink supply tube 10 includes the third layer 16, an adhesive strength can be improved as compared with the case where the second layer 14 and the fourth layer 18 are directly adhered. Here, the adhesive strength can be represented by a load when the two adhered layers are peeled off from each other.

The ink supply tube 10 includes the first layer 12 made of the unmodified ETFE resin, the second layer 14 made of the modified ETFE resin, and the fourth layer 18 made of the EVOH resin, and thus has the chemical resistance and the gas barrier property. The fifth layer 20 is made of the modified polypropylene resin into which the acid functional group has been introduced, and thus the bonding strength with the fourth layer 18 can be improved.

By forming the third layer 16 with the modified polypropylene resin, the ink supply tube 10 has the first layer 12 made of the unmodified ETFE resin, the second layer 14 made of the modified ETFE resin, and the third layer 16 and the fifth layer 20 that are made of the modified polypropylene resin, and thus has a quadruple low moisture permeability.

The third layer 16 is made of the modified polypropylene resin into which the basic functional group has been introduced, and the fifth layer 20 is made of the modified polypropylene resin into which the acid functional group has been introduced, thereby respectively suppressing a decrease in the transparency. Accordingly, in the ink supply tube 10, the ink flowing inside can be better visually recognized from outside. Forming the third layer 16 and the fifth layer 20 with the modified polypropylene resin can improve a formability.

### Modified Examples

The present invention is not limited to the above embodiment, and can be appropriately modified within the scope of the gist of the present invention.

### EXAMPLES

Subsequently, examples of the ink supply tube of the embodiment described above and comparative examples thereof will be described.

Here, the first layer as an innermost layer in contact with the ink, and the second layer, the third layer, the fourth layer, and the fifth layer from the outside of the first layer were formed by the co-extrusion molding to prepare samples of the ink supply tube (Example 1, Example 2, and Comparative Example 1 to Comparative Example 5). As the material of the first layer, the unmodified ETFE resin or the modified ETFE resin (the modified ETFE resin) was used. As the material of the second layer, the modified ETFE resin was used. As the material of the third layer, the polyamide resin (PA612) or the modified polypropylene resin modified with the basic functional group was used. As the material of the fourth layer, the EVOH resin having the ethylene composition ratio of 27 mol % or 32 mol % was used. As the material of the fifth layer, the formed polypropylene resin modified with the acid functional group, or PA612 was used. The ink supply tube having the five-layer structure was molded by extruding the five types of resin simultaneously by the co-extrusion molding. The sizes of the ink supply tubes were all 6 mm in outer diameter and 4 mm in inner diameter, and the total thickness of the first layer to the fifth layer was 1 mm (that is, (6 mm−4 mm)/2=1 mm).

In addition, according to functions of the first layer, the second layer, the third layer, the fourth layer, and the fifth layer described above, the first layer is referred to as the inner layer or a liquid contact layer, the second layer is referred to as a first adhesive layer, the third layer is referred to as a second adhesive layer, the fourth layer is referred to as a gas barrier layer, and the fifth layer is also referred to as the outer layer.

Here, seven types of ink supply tubes of Example 1, Example 2, and Comparative Example 1 to Comparative Example 5 in total as shown in Table 1 below were manufactured by combining the above materials and the thickness of each layer, and the ink residue, the adhesive strength, the transparency, and the gas barrier property thereof were evaluated. The evaluation results of the ink residue, the adhesive strength, the transparency, and the gas barrier property will be described later with reference to Table 2 to Table 5.

Additionally, as shown in Table 1, Comparative Example 1, Comparative Example 2, and Comparative Example 4 actually have a three-layer structure, but from the viewpoint of the material and the function of each of the layers, for example, the layers actually corresponding to the second layer and the third layer in Comparative Example 1 are shown in the columns of “Fourth layer” and “Fifth layer” in Table 1, and are hereinafter respectively referred to as the fourth layer and the fifth layer. Moreover, similarly, the layers actually corresponding to the second layer and third layer in Comparative Example 2 are shown in the columns of “Fourth layer” and “Fifth layer” in Table 1, and are hereinafter respectively referred to as the fourth layer and the fifth layer. Further, similarly, the layer actually corresponding to the third layer in Comparative Example 4 is shown in the column of “Fifth layer” in Table 1, and is hereinafter referred to as the fifth layer.

TABLE 1

| | | | | Comparative | Comparative | Comparative | Comparative | Comparative |
|---|---|---|---|---|---|---|---|---|
| | | Example 1 | Example 2 | Example 1 | Example 2 | Example 3 | Example 4 | Example 5 |
| First | Material | ETFE | ETFE | Modified | Modified | ETFE | ETFE | ETFE |
| layer | | | | ETFE | ETFE | | | |
| | Thickness | 0.1 | 0.1 | 0.1 | 0.1 | 0.1 | 0.1 | 0.2 |
| Second | Material | Modified | Modified | — | — | Modified | Modified | Modified |
| layer | | ETFE | ETFE | | | ETFE | ETFE | ETFE |
| | Thickness | 0.1 | 0.1 | — | — | 0.1 | 0.1 | 0.2 |
| Third | Material | PA612 | Basic | — | — | PA612 | — | Basic |
| layer | | | functional | | | | | functional |
| | | | group- | | | | | group- |
| | | | modified PP | | | | | modified PP |
| | Thickness | 0.05 | 0.05 | — | — | 0.05 | — | 0.3 |
| Fourth | Material | EVOH, | EVOH, | EVOH, | EVOH, | EVOH, | — | EVOH, |
| layer | | 27 mol % | 27 mol % | 27 mol % | 32 mol % | 27 mol % | | 27 mol % |
| | Thickness | 0.05 | 0.05 | 0.05 | 0.05 | 0.05 | — | 0.05 |
| Fifth | Material | Acid | Acid | Acid | Acid | PA612 | Basic | Acid |
| layer | | functional | functional | functional | functional | | functional | functional |
| | | group- | group- | group- | group- | | group- | group- |
| | | modified PP | modified PP | modified PP | modified PP | | modified PP | modified PP |
| | Thickness | 0.70 | 0.70 | 0.85 | 0.85 | 0.70 | 0.80 | 0.25 |

Table 1 shows the material and the thickness of each layer of Example 1, Example 2, and Comparative Example 1 to Comparative Example 5. The thicknesses described in Table 1 to Table 5 are all design values, and the unit is mm. In Table 1 and Table 2 to Table 5 to be described later, the unmodified ETFE is simply referred to as the “ETFE”, and the modified ETFE is referred to as the “modified ETFE”. In addition, in Table 1 to Table 5, the polypropylene resin is abbreviated as the “PP”.

In Table 1, for both Example 1 and Example 2, the first layer is the unmodified ETFE, and the ratio of the total thickness of the first layer to the fourth layer to the entire thickness is 4/10 or less. In addition, the ratio of the total thickness of the first layer to the third layer to the entire thickness is 4/10 or less in Example 1 and Example 2. The polyamide resin of the third layer of Example 1 is PA612, whereas the third layer of Example 2 is the basic functional group-modified polypropylene, which is the difference therebetween.

Further, among the comparative examples, Comparative Example 1 and Comparative Example 2 are different from Example 1 and Example 2 in that the first layer is the modified ETFE and the second layer and the third layer are not provided. Moreover, Comparative Example 3 is different from Example 1 and Example 2 in that the fifth layer is not made of the acid functional group-modified PP, and Comparative Example 4 is different from Example 1 and Example 2 in that the third layer and the fourth layer are not provided. Comparative Example 5 is different from Example 1 and Example 2 in that the ratio of the total thickness of the first layer to the fourth layer to the entire thickness and the ratio of the total thickness of the first layer to the third layer to the entire thickness are both 4/10 or more.

Table 2 shows the evaluation results of the ink residue. The ink residue was evaluated by circulating an ink paint in the ink supply tube for 7 days, then cleaning the tube by flowing with a thinner for 30 seconds, and checking paint residue in a red direction with a color difference meter. As the ink paint, a 2:1 mixture of RETAN PG ECO FLEET (trademark) Strong Red Paste and RETAN ECO THINNER (trademark) manufactured by Kansai Paint Co., Ltd. was used. As the color difference meter, CR-400 manufactured by KONICA MINOLTA SENSING, INC. was used.

In the evaluation test of the ink residue, as shown in Table 2, the ink residue was evaluated in two stages, with a remaining amount of the ink in the modified ETFE being set as a reference “◯”, and the remaining amount of the ink less than the reference being set as “⊙”. According to Table 2, Example 1, Example 2, and Comparative Example 3 to Comparative Example 5 in which the first layer is the unmodified ETFE are evaluated as “⊙”, and Comparative Example 1 and Comparative Example 2 in which the first layer is the modified ETFE are evaluated as “◯”. From this result, it can be said that the unmodified ETFE can reduce the ink residue in the ink supply tube as compared with the modified ETFE.

TABLE 2

| | | | Comparative | Comparative | Comparative | Comparative | Comparative |
|---|---|---|---|---|---|---|---|
| | Example 1 | Example 2 | Example 1 | Example 2 | Example 3 | Example 4 | Example 5 |
| First layer | ETFE | ETFE | Modified | Modified | ETFE | ETFE | ETFE |
| | | | ETFE | ETFE | | | |
| Ink residue | 0.28 | 0.28 | 0.36 | 0.36 | 0.28 | 0.28 | 0.28 |
| property | | | | | | | |
| Evaluation | ⊙ | ⊙ | ◯ | ◯ | ⊙ | ⊙ | ⊙ |

Table 3 shows the evaluation results of the adhesive strength. The adhesive strength was evaluated by evaluating the adhesive strength between the fourth layer as the barrier layer and a layer in contact with the inside of the fourth layer, and the adhesive strength between the fourth layer and a layer in contact with the outside of the fourth layer. Accordingly, the adhesive strengths of Example 1, Example 2, Comparative Example 3 and Comparative Example 5 are represented by the adhesive strength between the fourth layer and the third layer, and the adhesive strength between the fourth layer and the fifth layer. The adhesive strengths of Comparative Example 1 and Comparative Example 2 are represented by the adhesive strength between the fourth layer and the first layer, and the adhesive strength between the fourth layer and the fifth layer. In addition, the adhesive strength was not evaluated for Comparative Example 4 without the third layer and the fourth layer.

The purpose of the adhesive strength evaluation is to investigate the possibility of a lowered gas barrier property caused by an inter-layer peeling off due to a long-term bending load and by cracks in the fourth layer when a sufficient adhesive strength cannot be obtained in the inside and outside of the fourth layer. The adhesive strength was evaluated by dividing the ink supply tube into two halves in a length direction, peeling off a portion of an end surface, and then using this as a sample to grasp each peeled portion to perform a tensile test. The test speed for the tensile test was 20 mm/min, the type of the tensile test was T-type peeling, and the test environment was with a temperature of 23° C. and a humidity of 50%.

In the evaluation test of the adhesive strength, as shown in Table 3, the adhesive strength was evaluated in three stages, with “⊙” for those having 10 N/cm or more, “◯” for those having 5 N/cm or more and less than 10 N/cm, and “x” for those having less than 5 N/cm. In the evaluation of the adhesive strength, according to Table 3, the adhesive strength between the fourth layer and an outside layer is evaluated as “⊙” in Example 1, Example 2, Comparative Example 1 to Comparative Example 3, and Comparative Example 5. Further, the adhesive strength between the fourth layer and an inside layer is evaluated as “⊙” in Example 1, Comparative Example 2, and Comparative Example 3, and is evaluated as “◯” in Example 2 and Comparative Example 5. The adhesive strength between the fourth layer and the inside layer in Comparative Example 1 is evaluated as “x”.

TABLE 3

| | | | | Comparative | Comparative | Comparative | Comparative |
|---|---|---|---|---|---|---|---|
| | | Example 1 | Example 2 | Example 1 | Example 2 | Example 3 | Example 5 |
| Inside | Material | PA612 | Basic | Modified | Modified | PA612 | Basic |
| layer | | | functional | ETFE | ETFE | | functional |
| | | | group- | | | | group- |
| | | | modified PP | | | | modified PP |
| | Thickness | 0.05 | 0.05 | 0.1 | 0.1 | 0.05 | 0.3 |
| Fourth | Material | EVOH, | EVOH, | EVOH, | EVOH, | EVOH, | EVOH, |
| layer | | 27 mol % | 27 mol % | 27 mol % | 32 mol % | 27 mol % | 27 mol % |
| | Thickness | 0.05 | 0.05 | 0.05 | 0.05 | 0.05 | 0.05 |
| Outside | Material | Acid | Acid | Acid | Acid | PA612 | Acid |
| layer | | functional | functional | functional | functional | | functional |
| | | group- | group- | group- | group- | | group- |
| | | modified PP | modified PP | modified PP | modified PP | | modified PP |
| | Thickness | 0.70 | 0.70 | 0.85 | 0.85 | 0.70 | 0.25 |
| Adhesive | Inside layer/ | Unpeelable | 7 | 4 | 16 | Unpeelable | 7 |
| strength | Fourth layer | ⊙ | ◯ | X | ⊙ | ⊙ | ◯ |
| N/cm | Fourth layer/ | 22 | 22 | 22 | 27 | Unpeelable | 22 |
| | Outside layer | ⊙ | ⊙ | ⊙ | ⊙ | ⊙ | ⊙ |

Table 4 is a table showing the evaluation results of the transparency. The transparency was evaluated by sealing a toluene in the ink supply tube and determining whether a level gage could detect (respond to) a liquid level of the sealed toluene. Such evaluation utilizes the fact that the level gauge responds when the ink supply tube has a certain or higher level of transparency, and the level gauge does not respond when the ink supply tube has a low transparency. The level gauge used for the evaluation was EE-SPX613 manufactured by OMRON Corporation, and the evaluation was performed in a sensitivity set to Low. The reason why the sensitivity is set to Low is that, when used in a small-diameter pipe with an outer diameter such as 6 mm, the level gauge does not operate stably due to its mechanism.

In the transparency evaluation test, as shown in Table 4, the transparency was evaluated in two stages, with “◯” indicating a response presence in the level gauge and “x” indicating no response. In the transparency evaluation, Example 1, Example 2, Comparative Example 1, Comparative Example 2, Comparative Example 4, and Comparative Example 5 are all evaluated as “◯”. On the other hand, the transparency of Comparative Example 3, the only example in which PA612 was used for the fifth layer, is evaluated as “x”. The transparency of the ink supply tube depends not only on the material of the fifth layer but also on the thickness and the material of other layers. As can be seen from Table 4 explained above, when the acid functional group-modified PP is used for the fifth layer and the thickness thereof is larger than the total thickness of the first layer to the third layer, a transparency to the extent that the liquid level of the toluene in the ink supply tube can be evaluated by the level gauge can be achieved.

TABLE 4

| | | | | Comparative | Comparative | Comparative | Comparative | Comparative |
|---|---|---|---|---|---|---|---|---|
| | | Example 1 | Example 2 | Example 1 | Example 2 | Example 3 | Example 4 | Example 5 |
| First | Material | ETFE | ETFE | Modified | Modified | ETFE | ETFE | ETFE |
| layer | | | | ETFE | ETFE | | | |
| | Thickness | 0.1 | 0.1 | 0.1 | 0.1 | 0.1 | 0.1 | 0.2 |
| Second | Material | Modified | Modified | — | — | Modified | Modified | Modified |
| layer | | ETFE | ETFE | | | ETFE | ETFE | ETFE |
| | Thickness | 0.1 | 0.1 | — | — | 0.1 | 0.1 | 0.2 |
| Third | Material | PA612 | Basic | — | — | PA612 | — | Basic |
| layer | | | functional | | | | | functional |
| | | | group- | | | | | group- |
| | | | modified PP | | | | | modified PP |
| | Thickness | 0.05 | 0.05 | — | — | 0.05 | — | 0.3 |
| Fourth | Material | EVOH, | EVOH, | EVOH, | EVOH, | EVOH, | — | EVOH, |
| layer | | 27 mol % | 27 mol % | 27 mol % | 32 mol % | 27 mol % | | 27 mol % |
| | Thickness | 0.05 | 0.05 | 0.05 | 0.05 | 0.05 | — | 0.05 |
| Fifth | Material | Acid | Acid | Acid | Acid | PA612 | Basic | Acid |
| layer | | functional | functional | functional | functional | | functional | functional |
| | | group- | group- | group- | group- | | group- | group- |
| | | modified PP | modified PP | modified PP | modified PP | | modified PP | modified PP |
| | Thickness | 0.70 | 0.70 | 0.85 | 0.85 | 0.70 | 0.80 | 0.25 |

| | | | | | | | |
|---|---|---|---|---|---|---|---|
| Response of level gauge | Response | Response | Response | Response | No | Response | Response |
| | presence | presence | presence | presence | response | presence | presence |
| Evaluation | ◯ | ◯ | ◯ | ◯ | X | ◯ | ◯ |

Table 5 is a table showing the evaluation results of the gas barrier property. It is known that when air outside the tube passes through the thickness of the tube and reaches the ink inside the tube, properties and coating accuracy of the ink will be affected. Thus, the gas barrier property is an important aspect for the ink supply tube. In the evaluation test of the gas barrier property, the gas barrier property was evaluated by placing a deaerated toluene solvent as a pseudo ink in the ink supply tube, sealing both ends hermetically, leaving the ink supply tube to stand for 7 days in an environment with the temperature of 23° C. and the humidity of 50%, and then measuring an oxygen saturation rate of the deaerated toluene solvent in the ink supply tube. The oxygen saturation rate was determined by assuming that an amount of dissolved oxygen in the deaerated toluene solvent was 0% and the amount of dissolved oxygen in a saturated solvent in which the toluene solvent had absorbed oxygen up to a saturation amount was 100%. The dissolved oxygen was measured by a dissolved oxygen meter, TD-51 manufactured by TOKO KAGAKU KENKYUJO. As the oxygen saturation rate becomes lower, a higher gas barrier property of the ink supply tube is indicated.

In the evaluation of the gas barrier property, as shown in Table 5, the gas barrier property was evaluated in three stages using the oxygen saturation rate of Comparative Example 4 as a reference in which problems such as deterioration had occurred in the ink, with those having an oxygen saturation rate equal to or higher than this reference oxygen saturation rate being evaluated as “x”, those having an oxygen saturation rate less than this reference oxygen saturation rate being evaluated as “◯”, and those having an oxygen saturation rate of 50% or less being evaluated as “⊙”. According to Table 5, Example 1, Example 2, Comparative Example 1, and Comparative Example 3 are evaluated as “⊙”. Additionally, Comparative Example 2 and Comparative Example 5 are evaluated as “◯”. The gas barrier property of Comparative Example 4 is evaluated as “x”.

TABLE 5

| | | | | Comparative | Comparative | Comparative | Comparative | Comparative |
|---|---|---|---|---|---|---|---|---|
| | | Example 1 | Example 2 | Example 1 | Example 2 | Example 3 | Example 4 | Example 5 |
| First | Material | ETFE | ETFE | Modified | Modified | ETFE | ETFE | ETFE |
| layer | | | | ETFE | ETFE | | | |
| | Thickness | 0.1 | 0.1 | 0.1 | 0.1 | 0.1 | 0.1 | 0.2 |
| Second | Material | Modified | Modified | — | — | Modified | Modified | Modified |
| layer | | ETFE | ETFE | | | ETFE | ETFE | ETFE |
| | Thickness | 0.1 | 0.1 | — | — | 0.1 | 0.1 | 0.2 |
| Third | Material | PA612 | Basic | — | — | PA612 | — | Basic |
| layer | | | functional | | | | | functional |
| | | | group- | | | | | group- |
| | | | modified PP | | | | | modified PP |
| | Thickness | 0.05 | 0.05 | — | — | 0.05 | — | 0.3 |
| Fourth | Material | EVOH, | EVOH, | EVOH, | EVOH, | EVOH, | — | EVOH, |
| layer | | 27 mol % | 27 mol % | 27 mol % | 32 mol % | 27 mol % | | 27 mol % |
| | Thickness | 0.05 | 0.05 | 0.05 | 0.05 | 0.05 | — | 0.05 |
| Fifth | Material | Acid | Acid | Acid | Acid | PA612 | Basic | Acid |
| layer | | functional | functional | functional | functional | | functional | functional |
| | | group- | group- | group- | group- | | group- | group- |
| | | modified PP | modified PP | modified PP | modified PP | | modified PP | modified PP |
| | Thickness | 0.70 | 0.70 | 0.85 | 0.85 | 0.70 | 0.80 | 0.25 |

| | | | | | | | |
|---|---|---|---|---|---|---|---|
| Oxygen dissolution rate | 27% | 25% | 31% | 52% | 40% | 78% | 61% |
| (Gas barrier property) | | | | | | | |
| Evaluation | ⊙ | ⊙ | ⊙ | ◯ | ⊙ | X | ◯ |

According to the present examples described above, Comparative Example 1, Comparative Example 3, and Comparative Example 4 are evaluated to be low in terms of the adhesive strength, the transparency, and the gas barrier property, respectively. Further, according to the present examples, Example 1 and Example 2 are evaluated to be higher than Comparative Example 5 in terms of the gas barrier property. Moreover, Example 1 and Example 2 are evaluated higher than Comparative Example 1 and Comparative Example 2 in terms of the ink residue. From this, it can be said that Example 1 and Example 2 according to the present invention are comprehensively evaluated higher than any of the ink supply tubes of the comparative examples.

### Reference Signs List

10: Ink supply tube
12: First layer
14: Second layer
16: Third layer
18: Fourth layer
20: Fifth layer

1. An ink supply tube comprising:
a first layer that is made of an unmodified ethylene-tetrafluoroethylene copolymer resin and is in contact with ink;
a second layer that is made of a modified ethylene-tetrafluoroethylene copolymer resin and is formed on an outer periphery of the first layer;
a third layer that is made of a polyamide resin or a basic functional group-modified polypropylene resin and is formed on an outer periphery of the second layer;
a fourth layer that is made of an ethylene-vinyl alcohol copolymer resin having a gas barrier property and is formed on an outer periphery of the third layer; and
a fifth layer that is made of an acid functional group-modified polypropylene resin and is formed on an outer periphery of the fourth layer.

2. The ink supply tube according to claim 1, wherein a ratio of a total thickness of the first layer, the second layer, the third layer, and the fourth layer to a total thickness of the first layer, the second layer, the third layer, the fourth layer, and the fifth layer is 4/10 or less.

3. The ink supply tube according to claim 1, wherein a ratio of a total thickness of the first layer, the second layer, and the third layer to the total thickness of the first layer, the second layer, the third layer, the fourth layer, and the fifth layer is 4/10 or less.

4. The ink supply tube according to claim 1, wherein the polyamide resin is PA612.

5. The ink supply tube according to claim 1, wherein an ethylene composition ratio of the ethylene-vinyl alcohol copolymer resin of the fourth layer is 27 mol % or more and 44 mol % or less.
